(19) United States
(12) Patent Application Publication
(10) Pub. No.: US 2017/0350188 A1
(43) Pub. Date: Dec. 7, 2017

(54) CORDLESS SHADE ROLLER

(71) Applicant: K. E. & KINGSTONE CO., LTD., TAIPEI (TW)

(72) Inventor: WEN-CHONG HUANG, TAIPEI (TW)

(21) Appl. No.: 15/170,431

(22) Filed: Jun. 1, 2016

(51) Int. Cl. E06B 9/60; E06B 9/42; E06B 9/264; E06B 9/322; E06B 9/24

(52) U.S. Cl. CPC E06B 9/60; E06B 9/42; E06B 9/264; E06B 2009/2405; E06B 2009/2458; E06B 2009/3222; E06B 2009/2435

(57) ABSTRACT

A cordless shade roller is revealed. The cordless shade roller includes a roller tube, a passive-end bracket set on a first end of the roller tube, and an active-end bracket disposed on a second end of the roller tube. The active-end bracket is a cap formed by assembly of a first cover with a second cover and having a narrow space therein. An S-shaped constant force spring is clipped in the narrow space of the cap. The S-shaped constant force spring consists of a first wound roll used as a storage drum, a second wound roll used as an output drum, and an S-shaped spring strip wound around the first wound roll and the second wound roll reversibly. No baffle is disposed on each of two sides of the first wound roll and of the second wound roll.

### BACKGROUND OF THE INVENTION

The present invention relates to a cordless shade roller, especially to a cordless shade roller in which a cord for retraction or extension of the shade is replaced by an S-shaped constant force spring.

Cordless shades are common shades designed for prevention of strangulation hazard to children from conventional shade cords. Refer to U.S. Pat. No. 5,787,952, U.S. Pat. No. 324,135, U.S. Pat. No. 2,868,285, U.S. Pat. No. 6,474,394, and U.S. Pat. No. 8,251,120, these are all related to cordless shades. Most of them use an S-shaped constant-force spring (or spring-steel ribbon in U.S. Pat. No. 8,251,120) to replace the cord for retracting or extending a roller tube of the shades. The S-shaped constant-force spring generally includes an S-shaped spring wound around a first wheel (or storage drum in U.S. Pat. No. 6,474,394) and a second wheel (or output drum in U.S. Pat. No. 6,474,394) respectively. The structure of the S-shaped constant-force spring is already known. Although the respective shade of these prior arts includes the S-shaped constant-force spring, they have different designs and structure. Or the use/type of the shade is limited. Thus these prior arts have been granted.

Refer to U.S. Pat. No. 8,251,120, a cordless blind structure is revealed. The cordless blind structure includes a blind body (1), a first end holder (2), a second end holder (3) and a limiting mechanism (4). The components, the structure and connection between the components are all defined in the claim 1. Thus the use/kind of the blind is limited. At the pleading stage of the case, the applicant further integrated the original claim 5 (dependent claim) “wherein the resilient unit further comprises a constant-force spring and baffles flanking the constant-force spring, the constant-force spring having an end disposed at the second end holder and another end coupled to the axial unit” into the claim 1 (independent claim). The claim scope was narrowed so that this patent has been granted. Thus it is learned that not only the use of the blind (the type of the blind, refer to claim 1) is limited, the structure/type of the resilient unit (41) of the limiting mechanism (4) is further limited due to the new limitation (original claim 5) within the claim of U.S. Pat. No. 8,251,120. For example, the resilient unit 41 comprises a constant-force spring 411 and baffles 412 flanking the constant-force spring 411. The baffles 412 flanking the constant-force spring 411 have become one of the elements of the claim.

The prior arts mentioned above have the following shortcomings: Firstly, although the above shades use an S-shaped constant force spring, the structure of the S-shaped constant force spring has been modified to have different designs. For example, the resilient unit (41) in U.S. Pat. No. 8,251,120 includes the baffles 412 flanking the constant-force spring 411 so that the applications of the resilient unit (41) have limitations. For production of a type of blind, an S-shaped constant force spring matched with the blind should be designed and molded. Each blind requires a specially-designed S-shaped constant force spring. The S-shaped constant force spring is not a standardized component. Thereby the manufacturing cost is increased. This has negative effect on mass production and production management of the S-shaped constant force spring.

Secondly, the respective S-shaped constant force spring of each blind has a plurality of components and complicated structure. For example, the resilient unit 41 in U.S. Pat. No. 8,251,120 includes the baffles 412 flanking the constant-force spring 411. The assembly of the resilient unit 41 is getting difficult and more space required for installation of the resilient unit 41. The use efficiency of the resilient unit 41 is reduced.

The conventional design of the S-shaped constant force spring has complicated structure, the problem of unable to be standardized, higher manufacturing and assembly cost and lower use efficiency, Thus there is room for improvement and a need to provide a novel design of the S-shaped constant force spring.

### SUMMARY OF THE INVENTION

Therefore it is a primary object of the present invention to provide a cordless shade roller that includes an S-shaped constant force spring that features on simple structure, standardization, lower manufacturing and assembly cost, and minimum space required.

In order to achieve the above object, a cordless shade roller according to the present invention includes a roller tube, a passive-end bracket arranged at a first end of the roller tube, and an active-end bracket set on a second end of the roller tube. The active-end bracket consists of a first cover, a second cover, and an S-shaped constant force spring. The S-shaped constant force spring includes a first wound roll used as a storage drum, a second wound roll used as an output drum, and an S-shaped spring strip wound around the first wound roll and the second wound roll. The first cover and the second cover are assembled to form a cover body with a narrow space therein. The S-shaped constant force spring is clipped in the narrow space. No baffle is disposed on each of two sides of the first wound roll and the second wound roll of the S-shaped constant force spring.

The cordless shade roller can be used in a blade-spring-type zebra shade, a blade-spring-type roller shade, or a blade-spring-type Shangri-la blind.

### BRIEF DESCRIPTION OF THE DRAWINGS

FIG. 1 is a perspective view showing an embodiment of a cordless shade roller applied to a blade-spring-type zebra shade according to the present invention;

FIG. 2 is a side view of the embodiment shown in FIG. 1 according to the present invention;

FIG. 3 is an explosive view of the embodiment shown in FIG. 1 according to the present invention;

FIG. 3A is an enlarged view of an S-shaped constant force spring of the embodiment in FIG. 3 according to the present invention;

FIG. 4 is an explosive view of the embodiment shown in FIG. 3 viewed from another angle according to the present invention;

FIG. 4A is an enlarged view of an S-shaped constant force spring of the embodiment in FIG. 4 according to the present invention;

FIG. 5 is an enlarged view of an active-end bracket of the embodiment in FIG. 4 according to the present invention;

FIG. 6 is a perspective view showing an embodiment of a cordless shade roller applied to a blade-spring-type roller shade according to the present invention;

FIG. 7 is a side view of the embodiment shown in FIG. 6 according to the present invention;

FIG. 8 is an explosive view of the embodiment shown in FIG. 6 according to the present invention;

FIG. 9 is an explosive view of the embodiment shown in FIG. 8 viewed from another angle according to the present invention;

FIG. 10 is an enlarged view of an active-end bracket of the embodiment in FIG. 9 according to the present invention;

FIG. 11 is a perspective view showing an embodiment of a cordless shade roller applied to a blade-spring-type Shangri-la blind according to the present invention;

FIG. 12 is a side view of the embodiment shown in FIG. 11 according to the present invention;

FIG. 13 is an explosive view of the embodiment shown in FIG. 11 according to the present invention;

FIG. 14 is an explosive view of the embodiment shown in FIG. 11 viewed from another angle according to the present invention.

### DETAILED DESCRIPTION OF THE PREFERRED EMBODIMENTS

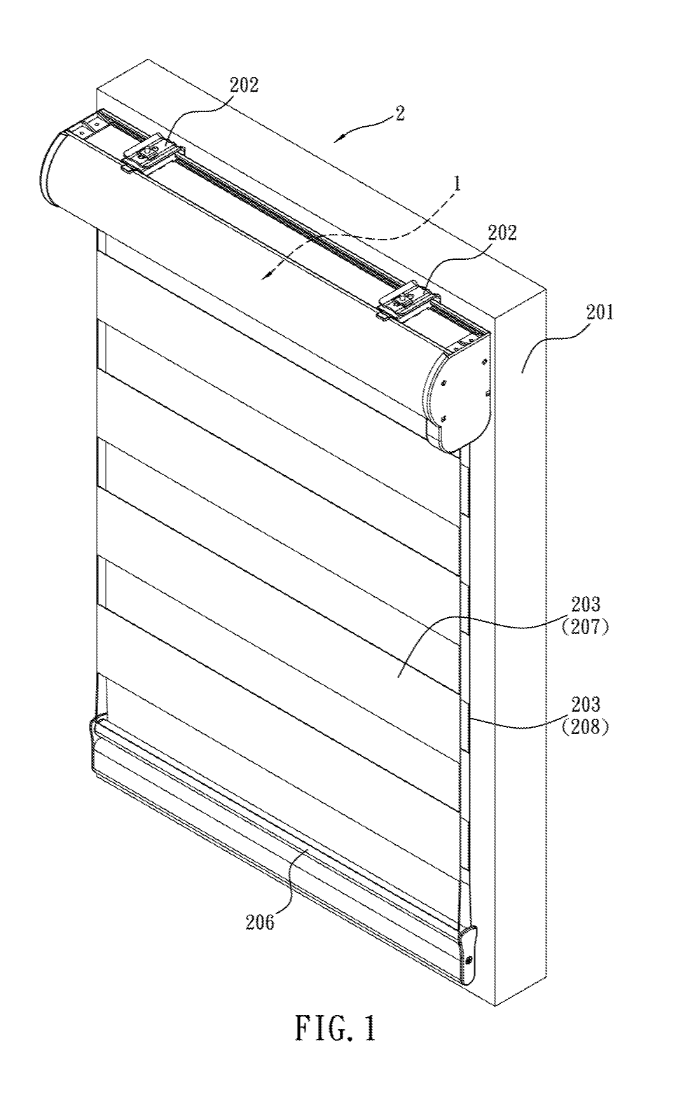

Refer from FIG. 1 to FIG. 5, a cordless shade roller 1 of the present invention is used in a blade-spring-type zebra shade 2.

The zebra shade includes a zebra fabric having transparent sections and non-transparent sections placed in parallel positions alternatively. The zebra fabric is used in combination with other accessories to form a front fabric and a rear fabric moved relative to each other. The overlapping of the transparent/non-transparent sections of the front/rear fabric can be adjusted by an operating mechanism. When the transparent sections of the front/rear fabric and the transparent sections of the rear/front fabric are completely overlapped and corresponding to each other, the shade is in a transparent state. Once the transparent sections of the front/rear fabric and the non-transparent sections of the rear/front fabric are completely overlapped and corresponding to each other, the shade is in a totally shaded (non-transparent) state. While the transparent/non-transparent sections of the front/rear fabric are partially overlapped, the shade is in a partially transparent/shaded state. Thus the adjustment of the Zebra shade transparency has been achieved.

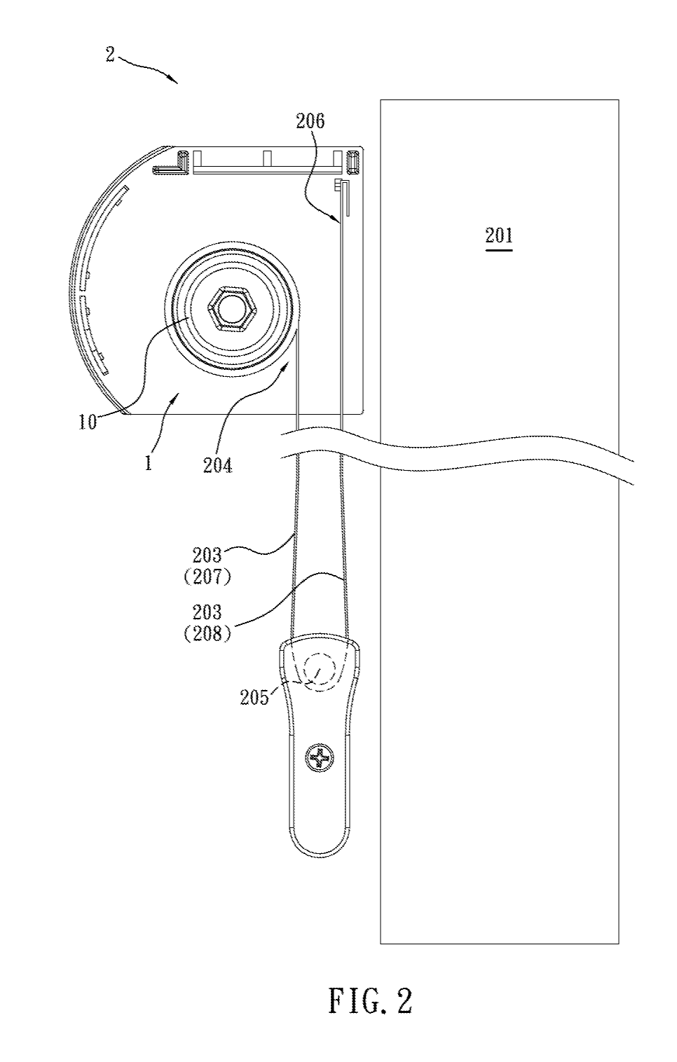

Refer to FIG. 1 and FIG. 2, a blade-spring-type zebra shade 2 is installed on an indoor side of a window 201. The installation way is not limited. For example, the zebra shade is affixed to an upper edge of the window 201 (ceiling) or walls on two sides thereof by brackets 202. The blade-spring-type zebra shade 2 mainly includes a zebra fabric 203 with a certain length/height, a head end 204 of the zebra fabric 203, a lower rod 205, a tail end 206 of the zebra fabric 203, a front fabric 207 and a rear fabric 208. The head end 204 of the zebra fabric 203 is wound and retracted around an outer surface 11 of a roller tube 10 while the zebra fabric 203 is extended from the head end 204 downward, wound around the lower rod 205 and then turned to extend upward. The tail end 206 of the zebra fabric 203 is fixed on and suspended from an upper edge. Thereby the zebra fabric 203 is divided into the front fabric 207 and the rear fabric 208 by the lower rod 205. The front fabric 207 and the rear fabric 208 are moved relative to each other.

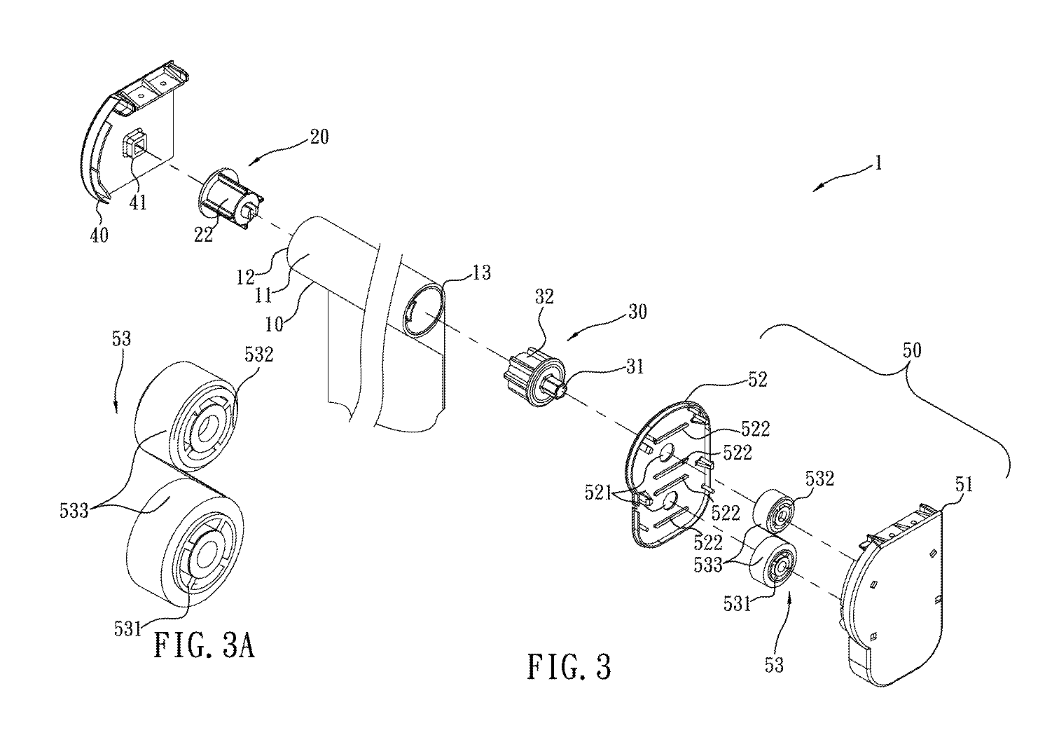

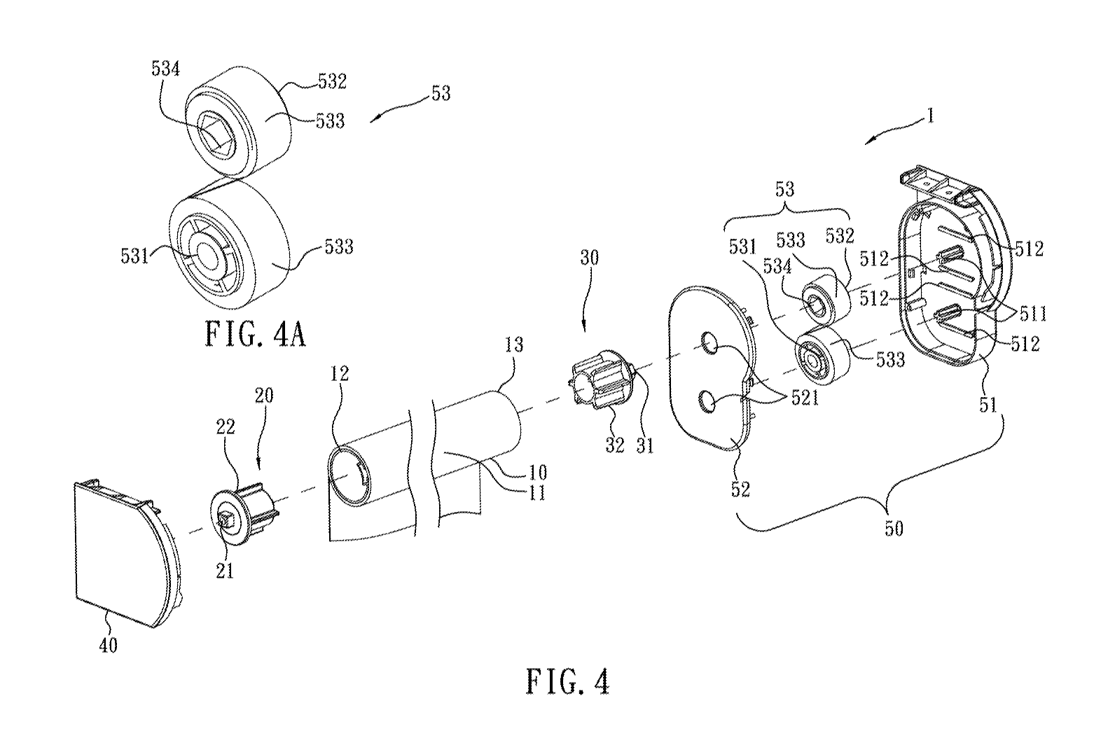

Refer to FIG. 3 and FIG. 4, a roller of cordless shades 1 according to the present invention is composed of a roller tube 10, a first shaft part 20, a second shaft part 30, a passive-end bracket 40, and an active-end bracket 50.

An outer surface 11 of the roller tube 10 is wound with the zebra fabric 203 of the blade-spring-type zebra shade 2. The first shaft part 20 is disposed on a first end 12 in an axial direction of the roller tube 10 and the second shaft part 30 is arranged at a second end 13 of the roller tube 10 that is opposite to the first end 12 of the roller tube 10.

The first shaft part 20 includes an axis part 21 extended outward and an outer shaft part 22 that is mounted in the first end 12 of the roller tube 10. Thus the roller tube 10 and the outer shaft part 22 can be rotated relative to the axis part 21.

The second shaft part 30 includes an axis part 31 extended outward and an outer shaft part 22 that is mounted in the second end 13 of the roller tube 10. Thus the roller tube 10 and the second shaft part 30 can be rotated synchronously.

The passive-end bracket 40 is set outside the first shaft part 20 on the first end 12 of the roller tube 10 and is having an axis base 41 used for supporting the axis part 21 of the first shaft part 20.

The active-end bracket 50 consists of a first cover 51, a second cover 52 and an S-shaped constant force spring 53 clipped in a narrow space formed by assembly of the first cover 51 with the second cover 52. Two separate pins 511 are extended from an inner side of the first cover 51 toward the second cover 52. The second cover 52 is set with two separate holes 521 corresponding to the separate pins 511 respectively. The S-shaped constant force spring 53 includes a first wound roll 531, a second wound roll 532, and an S-shaped spring strip 533. The first wound roll 531 is fitted on one of the pins 511 and is used as a storage drum. The second wound roll 532 is fitted on the other pin 511 and is used as an output drum. The S-shaped spring strip 533 is wound around the first wound roll 531 and the second wound roll 532 in a reversible way, as shown in FIG. 3A. The first cover 51 and the second cover 52 are assembled to form a cover body with a narrow space therein.

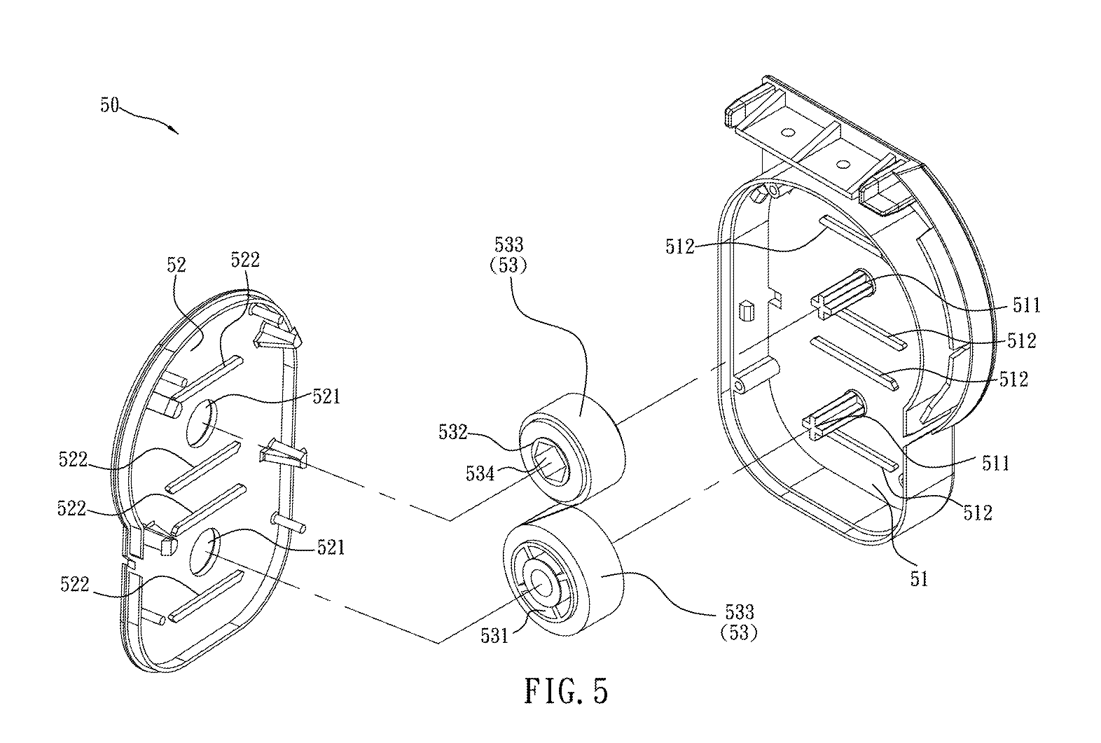

Refer to FIG. 5, the first wound roll 531 and the second wound roll 532 of the S-shaped constant force spring 53 are fitted on the pins 511 correspondingly while being assembled. The S-shaped spring strip 533 is wound around the first wound roll 531 and the second wound roll 532 reversibly, as shown in FIG. 3A. Then the second cover 52 is covered on. The axis part 31 extended outward from the second shaft part 30 is passed through the corresponding hole 521 to be mounted in an axial hole 534 of the second wound roll 532. Thus the second wound roll 532 and the second shaft part 30 can be rotated synchronously along with the roller tube 10 under the action of the S-shaped constant force spring 53.

The present invention features on that the S-shaped constant force spring 53 is directly clipped in the narrow space formed by the first cover 51 assembled with the second cover 52. No baffle is disposed on each of two sides of the first wound roll 531 (storage drum) and of the second wound roll 532 (output drum), as shown in FIG. 3A, FIG. 4A and FIG. 5. The manufacturing and assembly cost of the baffle is saved. There is no need to reserve the space required for arrangement of the baffle.

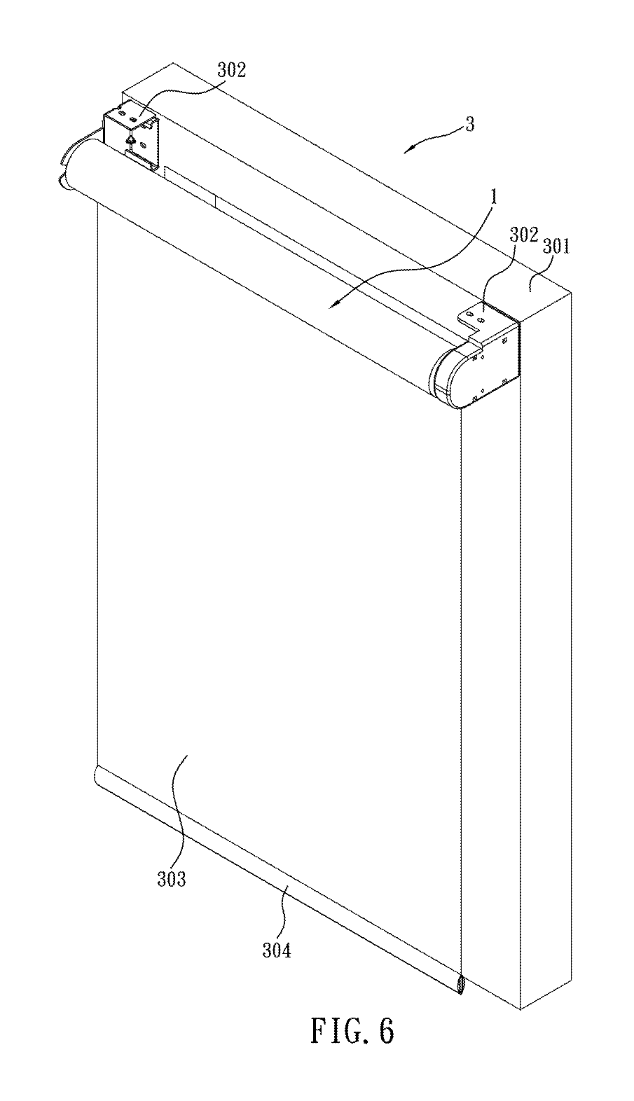

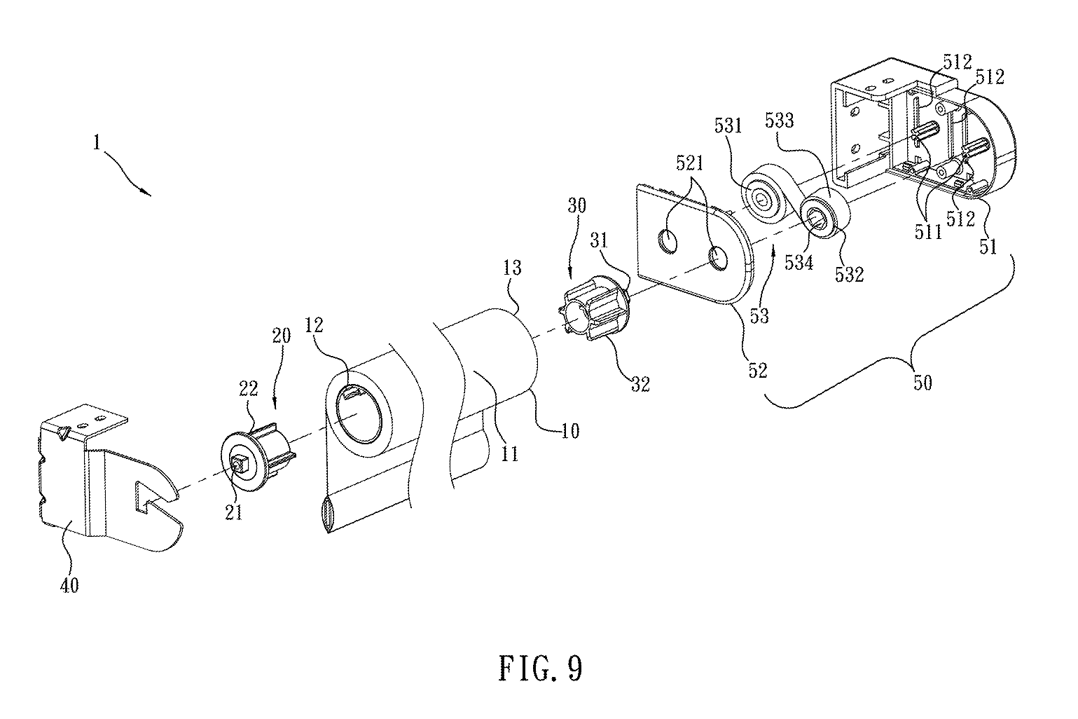

Refer from FIG. 6 to FIG. 10, a cordless shade roller 1 of the present invention is used in a blade-spring-type roller shade 3. The structure of the cordless shade roller 1 used in the blade-spring-type roller shade 3 is the same as the structure of the cordless shade roller 1 shown from FIG. 1 to FIG. 5.

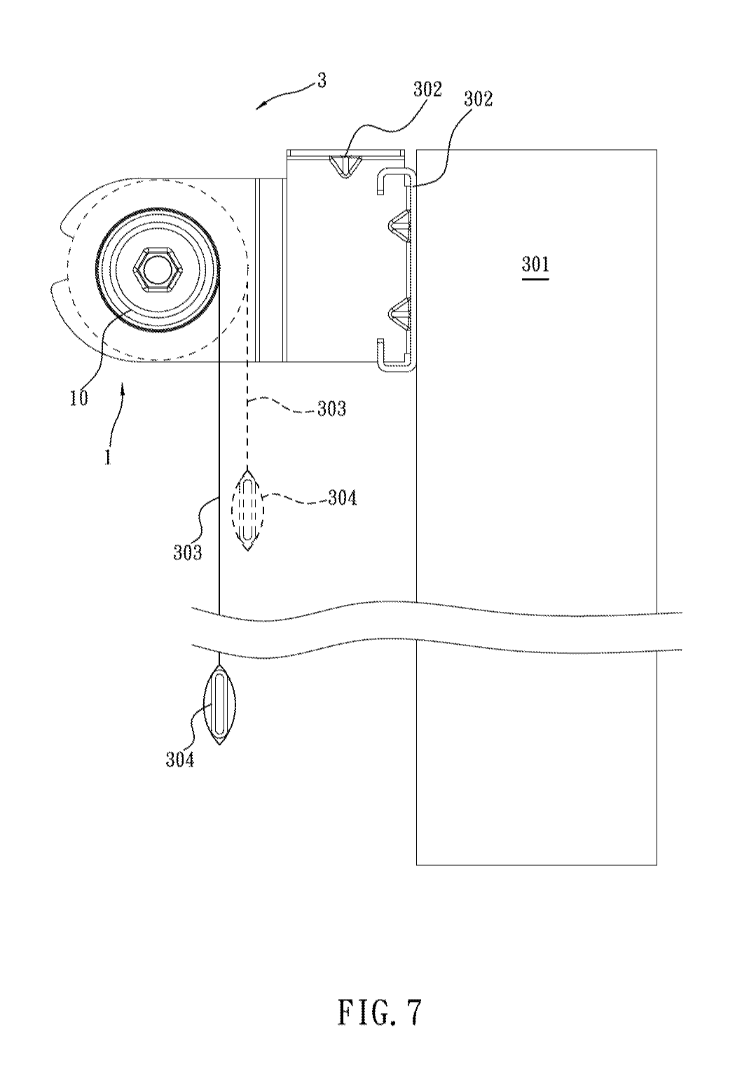

The blade-spring-type roller shade 3 is a common blind. The blade-spring-type roller shade 3 of this embodiment is disposed on an indoor side of a window 301. The installation way is not limited. For example, the shade 3 is fastened on an upper edge of the window 301 (such as ceiling) or walls on two sides thereof by brackets 302. The blade-spring-type roller shade 3 is composed of a fabric 303 with a certain length/height. A head end of the fabric 303 is wound and retracted around an outer surface of a roller tube 10 of the roller 1 while a rear end (lower end) of the fabric 303 is covered over a lower rod (or a weighted rod) 304. The fabric 303 is extended downward by the lower rod (or a weighted rod) 304 being pulled down, or retracted upward and wound around the roller tube 10 by the lower rod (or a weighted rod) 304 being activated, as break lines shown in FIG. 7.

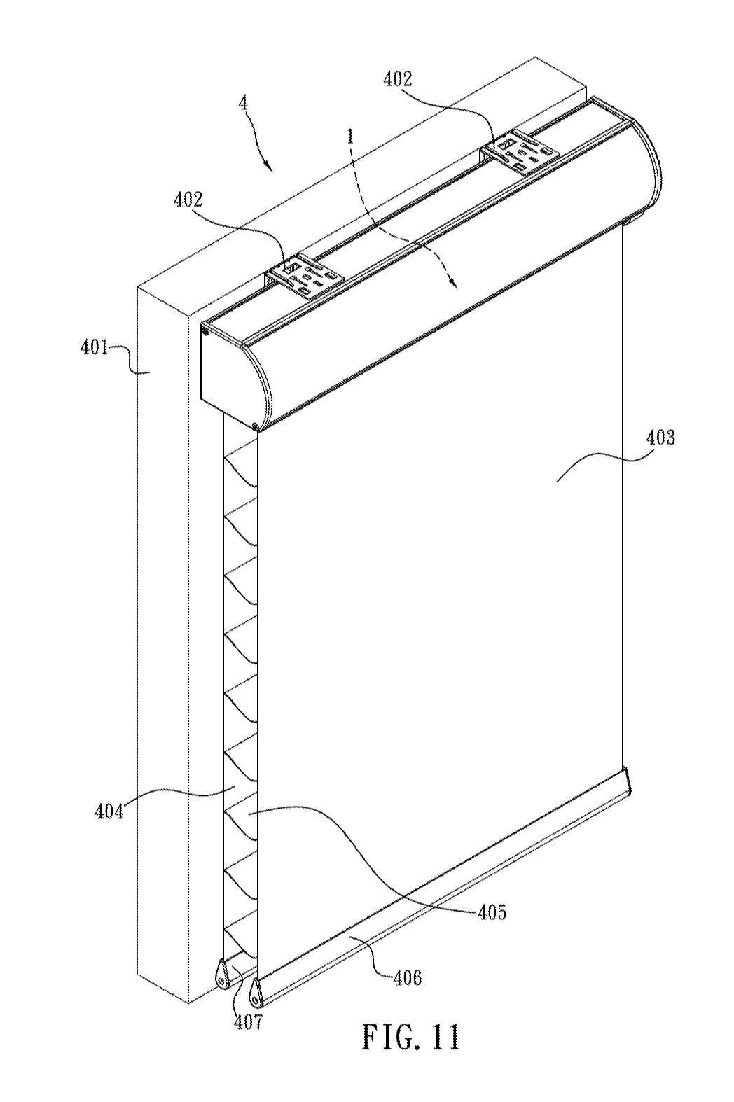

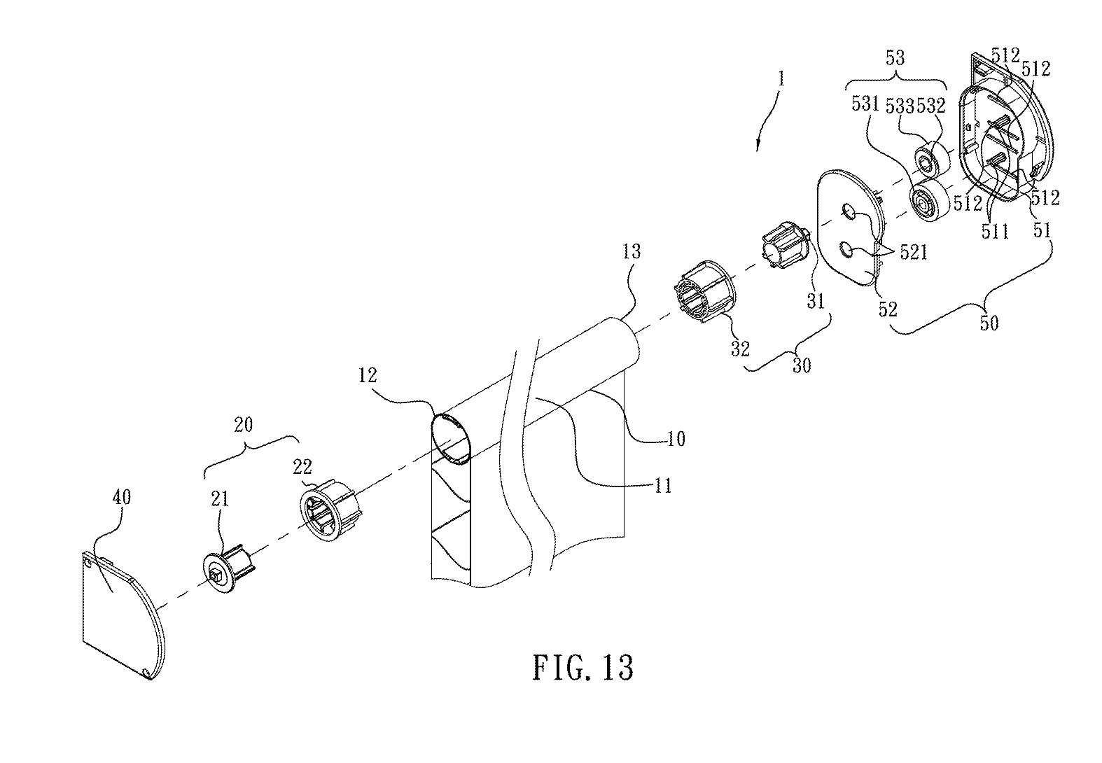

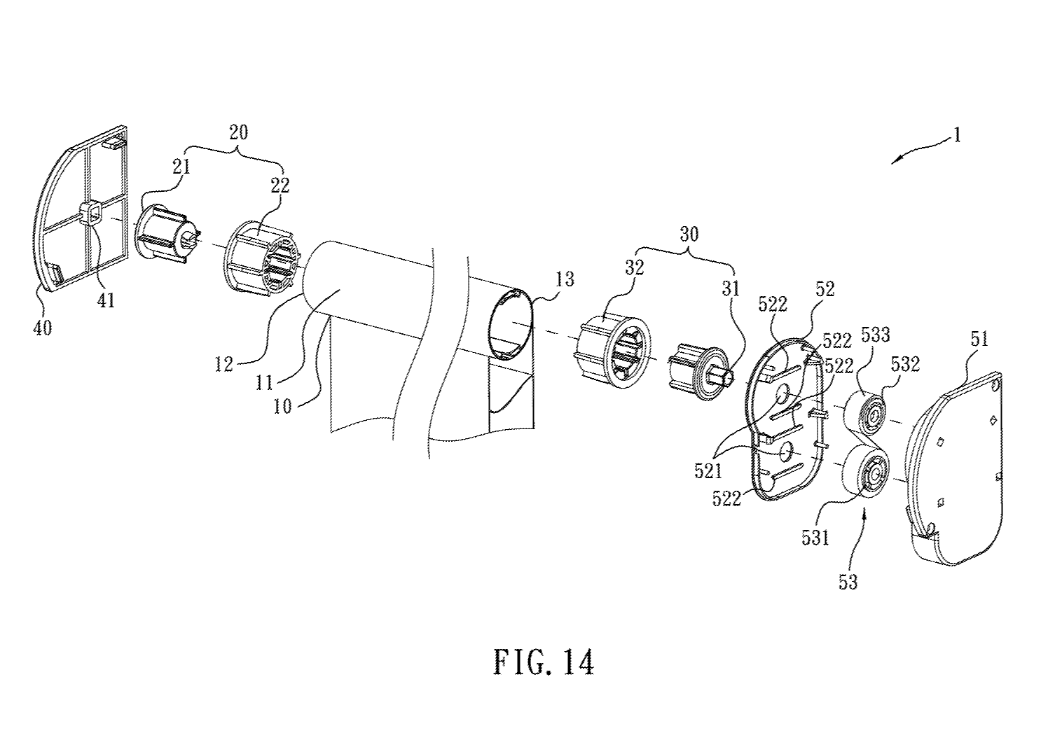

Refer from FIG. 11 to FIG. 14, a cordless shade roller 1 of the present invention is used in a blade-spring-type Shangri-la blind 4. The structure of the cordless shade roller 1 used in the blade-spring-type Shangri-la blind 4 is the same as the structure of the cordless shade roller 1 shown from FIG. 1 to FIG. 5.

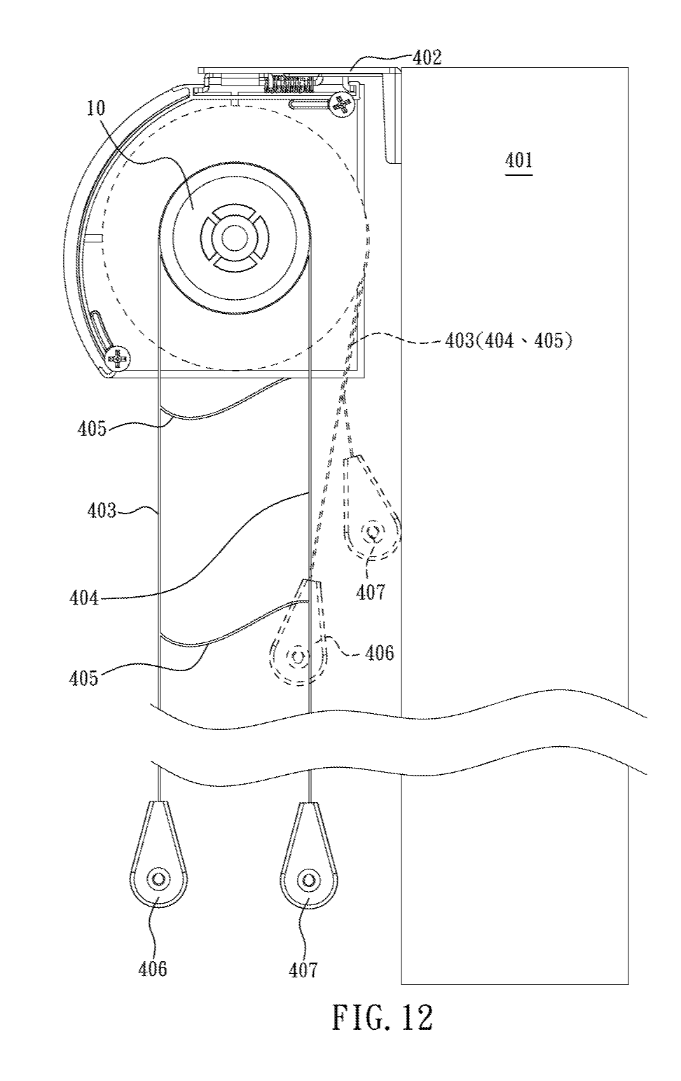

The blade-spring-type Shangri-la blind 4 is a common blind. The blade-spring-type Shangri-la blind 4 of this embodiment is arranged at an indoor side of a window 401. The installation way is not limited. For example, the blind 4 is secured on an upper edge of the window 401 (such as ceiling) or walls on two sides thereof by brackets 402. The blade-spring-type Shangri-la blind 4 consists of a transparent front fabric 403 fixed on one side of a roller tube 10, a transparent rear fabric 404 attached to the other side of the roller tube 10, and a plurality of non-transparent step-like fabric 405 vertically arranged at equal intervals in an S-shaped manner between the front fabric 403 and the rear fabric 404. A lower rod (or weighted rod) 406, 407 is set on a bottom end of the front fabric 403 and the rear fabric 404 respectively. While in use, the transparent front fabric 403 and the rear fabric 404 are separated from each other and located at a front side and a rear side respectively while each non-transparent step-like fabric 405 is vertically arranged between the front fabric 403 and the rear fabric 404 in an S-shaped manner, as shown in FIG. 11 and FIG. 12. The lower rod (or the weighted rod) 406 of the front fabric 403 is pulled to the lowest position and then the lower rod 407 of the rear fabric 404 is pulled. Thus the blade-spring-type Shangri-la blind 4 is in an opened state and the user can see through the blind. At the moment, the lower rod 406 of the front fabric 403 is pulled down a bit and then is pushed upward so that the transparent front fabric 403 and the rear fabric 404 are closed to each other and each non-transparent step-like fabric 405 is in a vertical state. Thus the blade-spring-type Shangri-la blind 4 is in a closed state and the user can't see through the blind. For retracting the blade-spring-type Shangri-la blind 4, the lower rod (or weighted rod) 406 of the front fabric 403 is pushed to activate the roller 1. Thereby the front fabric 403 and the rear fabric 404 are retracted and wound around the roller tube 10 by the action force of the S-shaped constant force spring 53, as break lines shown in FIG. 12. The blade-spring-type Shangri-la blind 4 is in the retracted form.

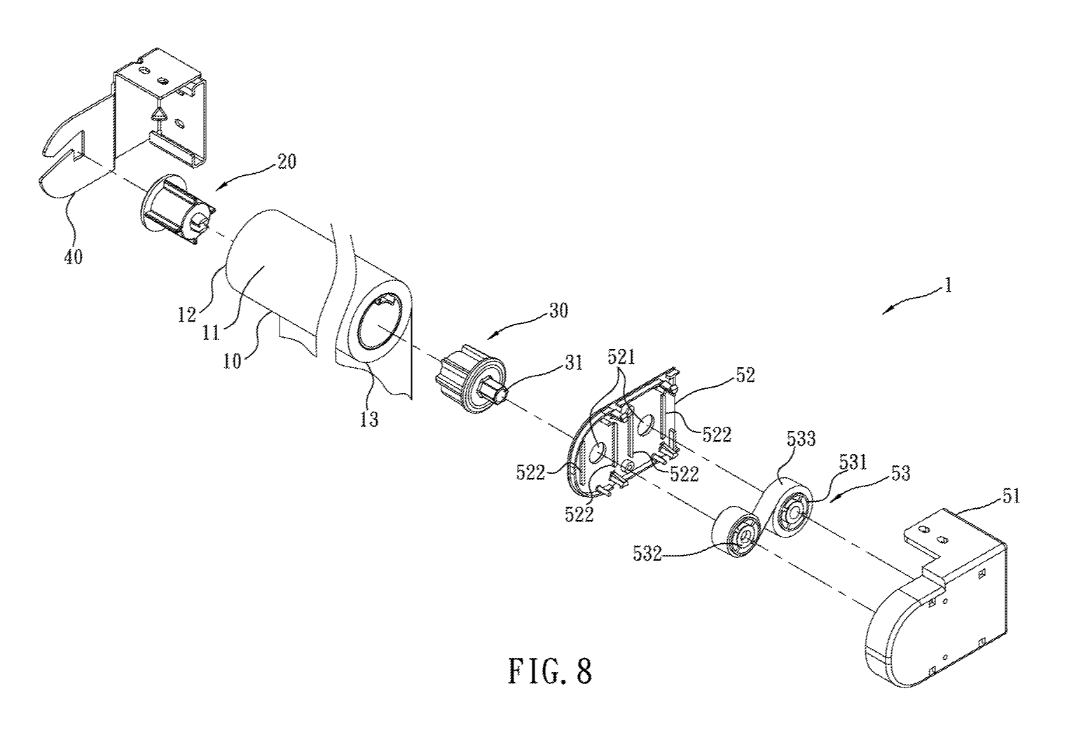

Although the embodiment of the cordless shade roller 1 being applied such as the blade-spring-type roller shade 3/or the blade-spring-type Shangri-la blind 4 is different from the blade-spring-type zebra shade 2 shown in FIG. 1 to FIG. 5, the function and purpose of the cordless shade roller 1 according to the present invention are almost the same. The only difference is in the shape/design of the passive-end bracket 40, the shape/design of the first cover 51 and the second cover 52 of the active-end bracket 50, or the arrangement of the two pins 511 of the first cover 51. The arrangement of the pins 511 is determined according to the installation direction, either in the vertical or horizontal direction. The installation direction of the pins 511 also affects the position of the S-shaped constant force spring 53 or the relative position of the first wound roll 531 and the second wound roll 532. For example, the shape of the active-end bracket 50 shown in FIG. 3-5 is different from that of the active-end bracket 50 shown in FIG. 8-10.

During production, the shape, the design of the appearance or the position of a part of the components of the cordless shade roller 1 such as the passive-end bracket 40, the first cover 51 and the second cover 52 of the active-end bracket 50, the two pins 511 of the first cover 51, etc. can be modified or not in various applications such as the blade-spring-type zebra shade 2, the blade-spring-type roller shade 3, or the blade-spring-type Shangri-la blind 4 as long as the function and purpose of the cordless shade roller 1 remain the same. Thus the cordless shade roller 1 with the same specification, shape or the design of the appearance can be applied to the blade-spring-type zebra shade 2 shown in FIG. 1-5, the blade-spring-type roller shade 3 shown in FIG. 6-10, or the blade-spring-type Shangri-la blind 4 shown in FIG. 11-14.

Moreover, the area around the two separate pins on the inner side of the first cover 51 and the area around the inner side of the two separate holes 521 of the second cover 52 are integrated with at least one projecting guide member 512, 522 respectively. The projecting guide members 512, 522 are used to replace the baffles set on two sides of the second wound roll 532 and/or the first wound roll 531 and limit the movement of the S-shaped spring strip 533 wound around the first wound roll 531 and the second wound roll 532 reversibly. The projecting guide members 512, 522 can also guide the S-shaped spring strip 533 to be wound around the first wound roll 531 and the second wound roll 532 orderly.

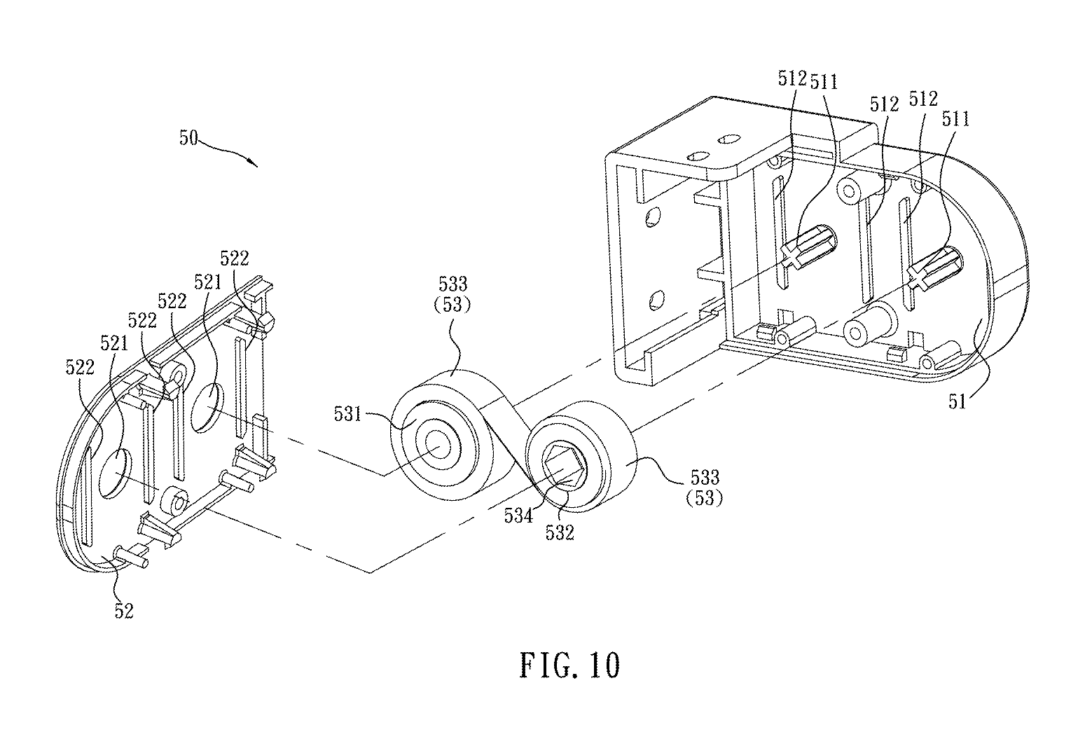

As to the shape of the projecting guide members 512, 522, it is not limited. Take the projecting guide members 512, 522 of the embodiments shown in FIG. 5 and FIG. 10 as examples. The projecting guide members 512, 522 are designed into long ribs with a certain length.

Furthermore, in the embodiments shown in FIG. 5 and FIG. 10, two long ribs are disposed on the area around the pins 511 and used as the projecting guide members 512. Similarly, two long ribs are arranged at the area around the holes 521 and used as the projecting guide members 522. The two long ribs (512) in FIG. 5 and FIG. 10 are (but not limited to) parallel to each other and so are the tow long ribs (522). The two long ribs (512, 522) can also be not parallel to each other.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A cordless shade roller comprising:
a roller tube whose outer surface is wound with shade fabric and having a first shaft part disposed on a first end in an axial direction thereof and a second shaft part arranged at a second end opposite to the first end;
a passive-end bracket that is set outside the first shaft part on the first end of the roller tube and having an axis base used for supporting an axis part of the first shaft part; and
an active-end bracket that includes a first cover, a second cover and an S-shaped constant force spring unit;
wherein two separate pins are extended from an inner side of the first cover toward the second cover; wherein the second cover is set with two separate holes corresponding to the two separate pins respectively;
wherein the S-shaped constant force spring unit includes a first wound roll fitted on one of the pins and used as a storage drum, a second wound roll fitted on the other pin and used as an output drum, and an S-shaped spring strip wound around the first wound roll and the second wound roll in a reversible way;
wherein the second shaft part includes an axis part extended outward and an outer shaft part that is mounted in the second end of the roller tube; the axis part is passed through one of the holes on the second cover to be mounted in an axial hole of the second wound roll of the S-shaped constant force spring unit so that the second wound roll and the second shaft part are able to be rotated synchronously along with the roller tube;
wherein the first shaft part includes the axis part extended outward and an outer shaft part that is mounted in the first end of the roller tube; thus the roller tube and the outer shaft part are able to be rotated relative to the axis part;
wherein at least one projecting guide member is integrated on an area around the two separate pins on the inner side of the first cover and a second area around the two separate holes on the inner side of the two separate holes of the second cover respectively; and
wherein the S-shaped constant force spring unit is clipped in a narrow space formed by assembly of the first cover with the second cover and no baffle or wheel wall for flanking the S-shaped constant force spring strip is disposed on each of two sides of the first wound roll and the second wound roll of the S-shaped constant force spring unit, so that each of two sides of the S-shaped constant force spring strip is against the at least one projecting guide member.

2. (canceled)

3. The device as claimed in claim 1, wherein two long ribs are disposed on the area around the two separate pins and used as the projecting guide members; two long ribs are arranged at the second area around the two separate holes and used as the projecting guide members; the two long ribs are parallel to each other.

4-8. (canceled)

9. The device as claimed in claim 1, wherein two long ribs are disposed on the area around the two separate pins and used as the projecting guide members; two long ribs are arranged at the second area around the two separate holes and used as the projecting guide members; the two long ribs are not parallel to each other.
